(19) United States
(12) Patent Application Publication
(10) Pub. No.: US 2024/0095357 A1
(43) Pub. Date: Mar. 21, 2024

(54) NETWORK-STORAGE-BASED ATTACK DETECTION

(71) Applicant: Dell Products L.P., Round Rock, TX (US)

(72) Inventors: Tomer Shachar, Omer (IL); Yevgeni Gehtman, Modi'in (IL); Maxim Balin, Gan - Yavne (IL); Arieh Don, Newton, MA (US)

(21) Appl. No.: 17/945,637

(22) Filed: Sep. 15, 2022

(51) Int. Cl. G06F 21/56

(52) U.S. Cl. CPC G06F 21/56

(57) ABSTRACT

A network-attached storage of a computing system connected to a network may monitor the network for file access commands from equipment of another computing system to identify whether one of the file access commands corresponds to a nefarious attempt to access information stored at the storage. A service, application, or script, running at the storage, may create a fake query and a fake response thereto. The fake query or corresponding response may contain information generated to attract an attacker that may be using the other computing system to passively monitor the network and, upon detecting the attractive, but fake, message information, transmit a request according to an address, or path, or other information that the fake message(s) may include. The service/app/script may notify the computing system that a potential hacker has infiltrated the system when it receives a request for information at the fake address or path.

### BACKGROUND

Modern data storage computer systems can facilitate the storage and manipulation of data by a variety of different network equipment. Data may be stored on a network storage component, which may be referred to as a storage, and which may comprise a hard drive, a magnetic media drive, a solid-state drive, a memory, and the like. Manipulation may refer to one or more actions performed to a storage unit, such as a file, or files, which actions may comprise reading, writing, copying, moving, deleting, and the like. Surreptitious use of or, access to the storage may be performed for nefarious purposes. In some circumstances, combinations of different file sharing commands can be used to cause adverse events on storage equipment. For example, file read instructions, or commands, can be used by malware, along with removal instruction, or commands, to obtain unauthorized access to data of an organization stored on a network storage. A passive attack may comprise an unauthorized attacker, for example, a human, a bot, an application, a network-connected device, and the like, monitoring and detecting data traffic to or from a network connected storage to determine how to obtain unauthorized access the storage. Passive monitoring by malicious network equipment or by a bad actor heretofore has been difficult, if not impossible, to detect at and by a network-accessible storage, or a network attached storage (“NAS”).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

A NAS may comprise one or more processors and software modules that perform various functions that may comprise functions related to security of the NAS and security relative to data or information stored on the NAS. Components of a NAS, including a processor and various software modules, may be referred to as security equipment for purposes of description herein.

In an example embodiment, a method comprises transmitting, by a system comprising a processor and a network-connected storage, such as a NAS, a lure response, stored at the network-connected storage, according to a lure identifier that comprises first information associated with lure information. The NAS may comprise a processor and software modules for performing functions related to the storage itself, or a processor, software modules, and the storage may be discrete components that collectively make up a part of a NAS apparatus. The processor may be part of the NAS or may be part of a computing system to which the NAS is coupled, or of which the NAS is a part. The lure identifier may comprise an address that appears to a network equipment component that may monitor or detect the lure response message as corresponding to interesting information. The method may comprise monitoring, by the system, the network-connected storage for at least one incoming request message; determining, by the system at the network-connected storage, that one of the at least one incoming request message was transmitted according to the lure identifier resulting in a determined lure request; and based on the determined lure request, causing, by the system at the network-connected storage, performance of an attack remediation action. The lure response may comprise a server message block (SMB) CONNECT command. The lure identifier comprises information in a path format.

The lure information may be generated based on at least one category of interest. The category of interested may be selected such that it is likely to be interesting to a malicious attacker, such as a bad actor or network equipment programmed with malware that is designed to monitor and detect message without making its activities detectable until it responds to a message containing interesting information (e.g., interesting to the malicious network equipment). The at least one category of interest may comprise at least one of: a first category relating to a non-publicly known technology, a second category relating to a first location of a meeting, a third category relating to planning of an event, a fourth category relating to finance, a fifth category relating to a status of an individual, a sixth category relating to a second location of the individual, a seventh category relating to a personal record of the individual, an eighth category relating to a third location of an item, a ninth category relating to a fourth location associated with a shipment of the item, a tenth category relating to shipping information associated with shipping the shipment, an eleventh category relating to health care, or a twelfth category relating to a military application.

The example method may further comprise generating, by the system at the network-connected storage, the lure identifier, wherein the lure identifier comprises a lure address.

The example method may further comprise transmitting a lure query to which the lure response message is responsive.

The lure query message may comprise second information associated with the lure information that is different than the first information.

In another example embodiment, a system may comprise a processor, configured to: transmit, as retrieved from a network-connected storage, a lure response message according to a lure identifier that comprises first information associated with lure information; monitor, at the network-connected storage, at least one incoming request message; determine, at the network-connected storage, that one of the at least one incoming request message was transmitted according to the lure identifier, resulting in a determined lure request; and based on the determined lure request, initiate, at the network-connected storage, performance of an attack remediation action. The system may comprise a NAS, or a NAS may comprise the system.

In another example embodiment, a non-transitory machine-readable medium example may comprise executable instructions that, when executed by a processor of a computing system, facilitate performance of operations, comprising: transmitting, from a network-connected storage, a lure response message according to a lure identifier that comprises first information associated with lure information; monitoring, at the network-connected storage, at least one incoming request message; determining, at the network-connected storage, that one of the at least one incoming request messages was transmitted according to the lure identifier, resulting in a determined lure request; and based on the determined lure request, enabling, at the network-connected storage, performance of an attack remediation action. The lure query message may comprise second information associated with the lure information different from the first information. The lure query message may comprise at least one file name associated with the lure information.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate monitoring file sharing and access commands between network equipment to identify adverse conditions, in accordance with one or more embodiments.

FIG. 2 is an architecture diagram of an example system that can facilitate generating fake network query and response messages to identify adverse conditions, in accordance with one or more embodiments.

FIG. 3 is an architecture diagram of an example system that can facilitate monitoring file sharing commands from network equipment attempting to access files or other information stored by a NAS without authorization, in accordance with one or more embodiments.

FIG. 4 depicts a diagram of an example network storage generation of fake query and response messages to detect attempts to access the storage without authorization.

FIG. 5 illustrates a diagram of a system mitigating an unauthorized attempt to access a network storage.

FIG. 6A depicts flow diagram of an example method embodiment to detect and mitigate attempts to obtain unauthorized access to a network-connected storage.

FIG. 6B depicts a flow diagram of an attacker attempting to access a network storage without authorization.

FIG. 7 illustrates an exemplary method embodiment.

FIG. 8 illustrates an exemplary server system embodiment.

FIG. 9 illustrates an exemplary non-transitory machine-readable medium embodiment.

FIG. 10 illustrates an example schematic block diagram of a computing environment with which the disclosed subject matter can interact.

FIG. 11 illustrates a table showing example lure query commands and corresponding lure responses.

### DETAILED DESCRIPTION

Generally speaking, one or more embodiments described herein can facilitate monitoring file sharing commands between network equipment to identify adverse conditions. One or more embodiments can use different approaches to, without adversely affecting system performance, detect adverse conditions that can occur when networked equipment uses resource sharing communications (e.g., commands) to alter data on data storage equipment. Monitoring and analyzing commands generated for data manipulation can, in one or more embodiments, result in the detection of malware before damage, such as unauthorized appropriation of data stored to a data store occurs. A data store, such as a hard drive, a magnetic disc drive, a solid-state drive, a memory, and the like, may be referred to as a storage, and may be implemented as a storage that is accessible to multiple computing device. A storage may be a cloud storage that is accessible by multiple computing devices via a network.

One having skill in the relevant art(s), given the description herein, appreciate that different types of malware and other adverse conditions can be handled in some circumstances, including, but not limited to, ransomware, file tampering, denial of service attacks, and data leakage. For example, in one or more embodiments, the resource sharing can be a combination of commands issued by the malicious network equipment that improperly, or without authorization, attempts to access resources stored by a NAS of the second network equipment. Additional illustrative examples are provided below.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

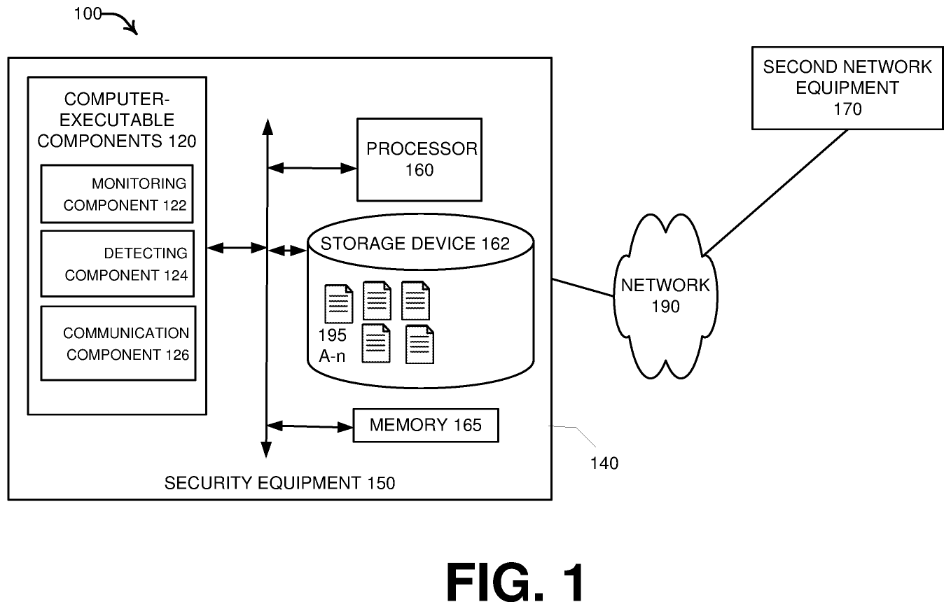

Turning now to FIG. 1, the figure illustrates an example system 100 that can facilitate monitoring file sharing and file access commands, such as read commands or copy commands, for example commands sent between network computing system equipment, to identify adverse conditions, in accordance with one or more embodiments. For purposes of brevity, description of like elements and/or processes employed in other embodiments is omitted. As depicted, system 100 comprises computing system 140 that may comprise security equipment 150. Security equipment 150 may comprise components that are configured, or programmed, to perform security functions in addition to other functions. Computing system 140 may be referred to herein as first network equipment 140. Security equipment 150 may be connected to, or communicatively coupled with, second network equipment 170 via network 190. According to multiple embodiments, security equipment 150 may include memory 165 that can store one or more computer and/or machine readable, writable, and/or executable components 120 and/or instructions. Security equipment 150 may comprise a computer service and may be referred to as a cloud storage service. Security equipment 150 may comprise components that make up part of a NAS, or a NAS may comprise components of security equipment 150. Network 190 may comprise multiple networks, such as an enterprise's private network, a public communication network such the Internet, an individual's home computing network corresponding to a firewall, a router, a switch, or a wireless communication network such as a 4G or 5G network, and the like.

In embodiments, security equipment 150 may further include processor 160 and storage device 162, which may be referred to simply as storage 162. In an embodiment, computer-executable components 120, processor 160, and memory 165 may be part of storage 162, which storage may be a network-connected storage, or NAS. In one or more embodiments, computer-executable components 120, when executed by processor 160, can facilitate performance of operations defined by the executable component(s) and/or instruction(s). Computer executable components 120 can include monitoring component 122, detecting component 124, communication component 126, and other components described or suggested by different embodiments described herein that can improve the operation of system 100. In one or more embodiments, computer-executable components 120 may be executed by, or run on, storage 162, or may be run on a NAS that comprises storage 162. Reference herein to storage 162 may comprise a reference to a NAS that comprises a storage device, such as a hard drive, a solid-state drive, a flash drive, or the like. Reference to storage 162 may comprise a reference to a storage device the is part of a NAS. In some example embodiments described here, reference to a storage, or to storage 162, may be deemed as including a description of a processor that is part of a NAS, or that corresponds to a NAS, performing, or being configured or programmed to perform, acts as described herein.

It will be appreciated that in some example embodiments, communication between second network equipment 170 and a component of first network equipment 140, such as storage 162, may comprise server message block (“SMB”) communication messages. It will also be appreciated that in one or more embodiments other communications protocols may provide similar means for facilitating activity between similarly arranged network equipment and computing system equipment.

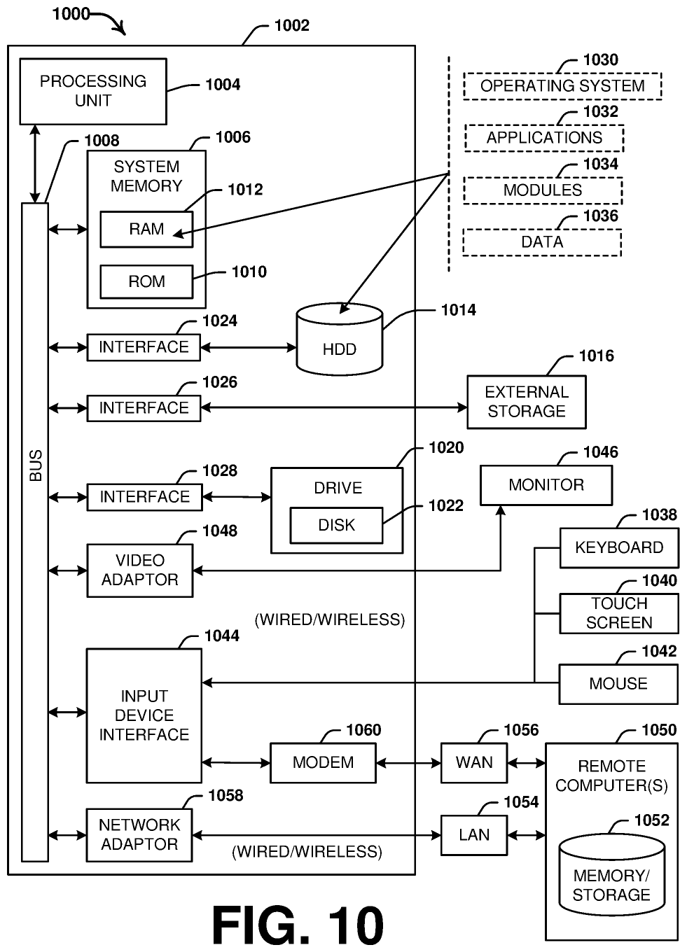

In some embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

As discussed further in reference to FIG. 10 below, network 190 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3× (5G Option 3×), high speed packet access (HSPA), Z-Wave, Zigbee and other 802.XX wireless technologies and/or legacy telecommunication technologies.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

It will be appreciated that the computer processing systems, computer-implemented methods, apparatus, computer program products, or non-transitory machine-readable medium that may comprise executable instructions that, when executed by a processor of a computing system, facilitate performance of operations, described herein may employ computer hardware and/or software to solve problems that are highly technical in nature (e.g., rapidly evaluating network command activity and controlling communication among devices in different contexts), that are not abstract and cannot be performed as a set of mental acts by a human. For example, a human, or even a plurality of humans, cannot apply criteria to activity of network equipment or of a network storage and provide a reporting, alerting, or corrective/mitigating action in a timely manner as can various embodiments described herein. Embodiments described herein may enhance the functionality of computing systems and network themselves

In one or more embodiments, memory 165 can store computer and/or machine readable, writable, and/or executable components 120 and/or instructions that, when executed by processor 160, can facilitate execution of the various functions described herein relating to monitoring component 122, detecting component 124, communication component 126, as well as other components to implement and provide functions to system 100, and some other embodiments described herein.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of monitoring component 122, which can in some implementations, monitor resource sharing communication between network equipment via a network. One or more embodiments can monitor (e.g., by security equipment 150), resource sharing communication between second network equipment 170 and first network equipment 140 via a network.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of detecting component 124, which in some implementations can, based on the resource sharing communication, detect or determine, by security equipment 150, a condition of the resource sharing communication that has a likelihood of indicating a defined adverse event, such as an unauthorized attempt to access a NAS, that has at least a threshold likelihood. A threshold likelihood may be the use by malicious network equipment of a lure identifier or other information contained in a lure query message or a lure response message to attempt to access a NAS. One or more embodiments can, based on the resource sharing communication, detect, by security equipment 150, a condition of the resource sharing communication (e.g., activity that may correspond to nefarious snooping, listening, ‘phishing’, and the like from a profile associated with second network equipment 170) that has a likelihood of indicating a defined adverse event (e.g., unauthorized attempt to access storage 162, data, or information 195 A-n stored contained therein from second network equipment 170) that has at least a threshold likelihood.

Use of lure identifier, as described in reference to other figures herein, to access a component, such as a NAS that may comprise security equipment 150 or storage 162, may indicate a nefarious attempt by second network equipment 170 to gain unauthorized access to storage 162 or information 195 A-n stored thereby. Thus, an attempt by second network equipment 170 to access storage 162 according to information contained in a lure query sent from security equipment 150 may indicate that the attempt corresponds to a message sent from an unauthorized actor or device

An approach to detecting an attempt to obtain unauthorized access to storage 162 from second network equipment 170 is to monitor a request for information, such as an address or a file name, that was transmitted as a query from the first network equipment 140, or in an embodiment from storage 162 or from a NAS that comprises storage 162.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation, operation, or functionality of communication component 126, which can in some implementations, in response to detecting a condition, such as a likelihood of nefarious snooping, listening, ‘phishing’, and the like, manage communication, such as facilitating suspending access by the second network equipment 170 to resources or information 195 A-n provided by first network equipment 150, which equipment may comprise, for example, storage 162. One or more embodiments can, in response to detecting the condition (e.g., potential nefarious snooping, listening, ‘phishing’, and the like), facilitate alerting of an attempt by second network equipment 170 to access first network equipment 140, or portions thereof, or facilitate suspending or blocking the granting of access to the second network equipment.

It will be appreciated that the embodiments of the subject disclosure depicted in various figures herein are for illustration only, and as such, the architecture of such embodiments are not limited to the systems, devices, and/or components depicted therein. For example, in some embodiments, security equipment 150 can further comprise various computer and/or computing-based elements described in reference to operating environment 1000 and FIG. 10. In one or more embodiments, such computer and/or computing-based elements can be used in connection with implementing one or more of the systems, devices, components, and/or computer-implemented operations shown and described in connection with FIG. 1 or other figures disclosed herein.

It should be noted that network equipment 140 may comprise computing equipment that can execute code instructions that may operate on servers or systems, remote data centers, ‘on-box’ in individual client information handling systems, or on a storage itself, such as storage 162, according to various embodiments herein. In some embodiments, it is understood that any or all implementations of one or more embodiments described herein can operate on a plurality of computers, collectively referred to as first network components 140.

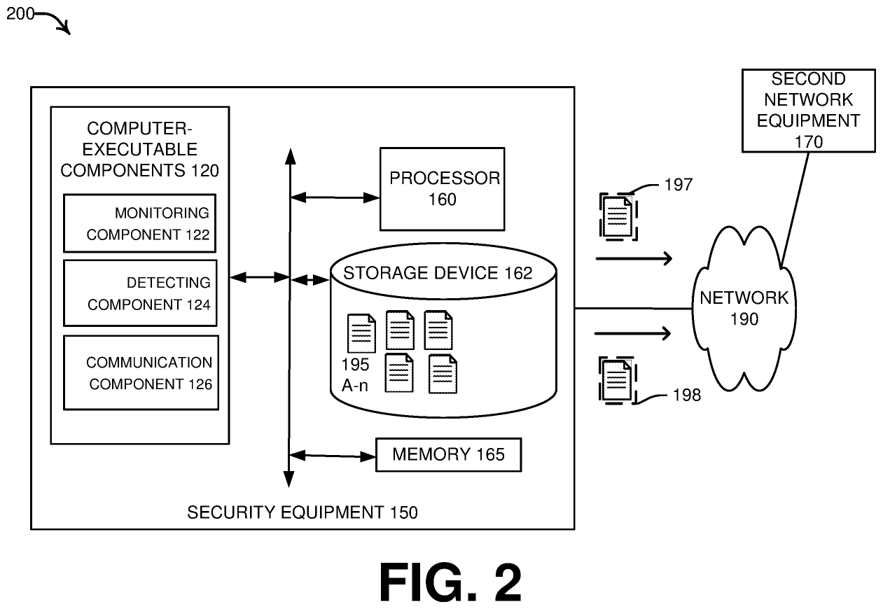

FIG. 2 illustrates system 200, which may facilitate monitoring file access request or commands, or other file manipulation commands, such as copy commands or read commands, from second network equipment 170 to identify adverse conditions, in accordance with one or more embodiments. For purposes of brevity, description of like elements and/or processes employed in other embodiments is omitted. System 200 may include network data storage equipment 162, which may be referred to as storage 162, connected to, or in communication with, data manipulating equipment, and security equipment 150. An unauthorized data access event may comprise sending, by second network equipment 170, commands to network storage 162 to read, copy, download, or otherwise obtain, without authorization, files, or access to files, data, or information 195A-n stored therein, from the network storage.

To determine that an unauthorized attempt to access information 195A-n from storage 162 may have occurred, security equipment 150 may ‘bait’ second network equipment 170 by generating and transmitting to network 190 a lure query message 197. Lure query message 197 may comprise a message that includes a request for fake information, which fake information may comprise text, numbers, symbols, or other representations of information, that may relate to a topic, or topics, that may appear attractive, or ‘alluring,’ to an attacking computing device, such as a component of second network equipment 170. The fake information may appear to be accessible as information 195 stored on storage 162, but the fake information may not exist, thus use of the term ‘fake information’. Security equipment 150 may generate and transmit to network 190 a lure response message 198 that contains information that makes the lure response message appear to be responsive to lure query message 197. The alluring information, which may be referred to herein as ‘lure information’, contained in, or referenced in, lure query message 197 or lure response message 198, may include information related to topics, or categories, such as, for example: financial information, secret technology, a location of a meeting, planning information relative to an event, finance, a status of an individual, a location of the individual, a personal record of the individual, a location of an item, a location of a shipment of the item, shipping information associated with a destination of a shipment, health care, or a military technology. It will be appreciated that the lure query message topics may comprise other topics and other categories than the categories and topics just listed. A lure query message 197 or a lure response message 198 may comprise network addresses, or other identifiers that may appear to be addresses, file names, path names, or other information that appears to be useful in facilitating access to the interesting information that may have been used as ‘bait’ to lure an attacker in attempting to access a component of first network equipment 140, such as for example, storage 162.

It will also be appreciated that terminology such as ‘bait’, ‘lure’, ‘alluring’ and the like are used as terms related to the outdoor sport fishing because actions in examples described herein may be analogous to fishing and may comprise actions that may be referred to in computing arts as a type of 'phishing, which phishing may be referred to as spoofing. Like a lure in fishing is meant to attract a fish to a hook, a lure query and lure response, may include information that is likely to be interesting to a nefarious attacker, or an attacking computing device that has been programmed by a nefarious attacker, or computer hacker. Thus, a lure query or lure response may be designed to attract an attacker, which may have been operating passivel, and thus may have been undetected by security equipment 150, to attempt to connected to storage 162 and retrieve information that it ‘saw’ in the lure query and response messages.

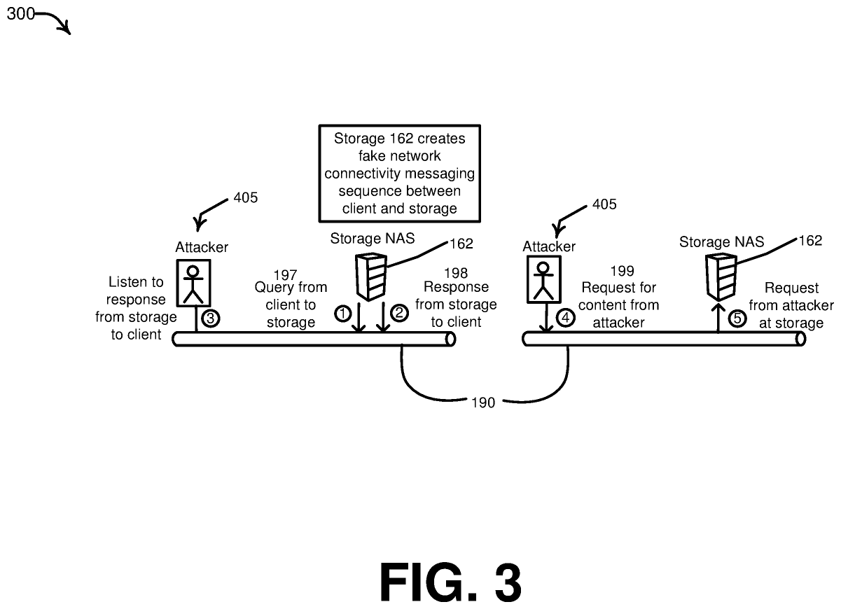

FIG. 3 illustrates example system 300 that can facilitate monitoring file sharing commands between network equipment to identify adverse conditions, in accordance with one or more embodiments. For purposes of brevity, description of like elements and/or processes employed in other embodiments is omitted. As depicted, system 300 includes security equipment 150 performing a monitoring 360 or request 199 transmitted by second network equipment 170. Request 199 may be referred to as a lure request or a determined lure request. To illustrate different aspects of system 300, monitoring component 122 and detecting component 124, described in reference to FIG. 1 above, may assist, or facilitate, or be part of storage 162, and may perform actions of determining that request 199 is directed to a lure identifier or lure information that was part of lure query 197 or lure reply 198.

As noted above, one or more embodiments can monitor and analyze communications between second network equipment 170 and first network equipment 140 to detect request that may indicate a likelihood of an unauthorized attempt to access storage 162, such as request 199 that may be directed to, or may have been transmitted according to, lure information, such as an address or identifier, that corresponds to fake information indicated in lure query 197 or lure reply 198.

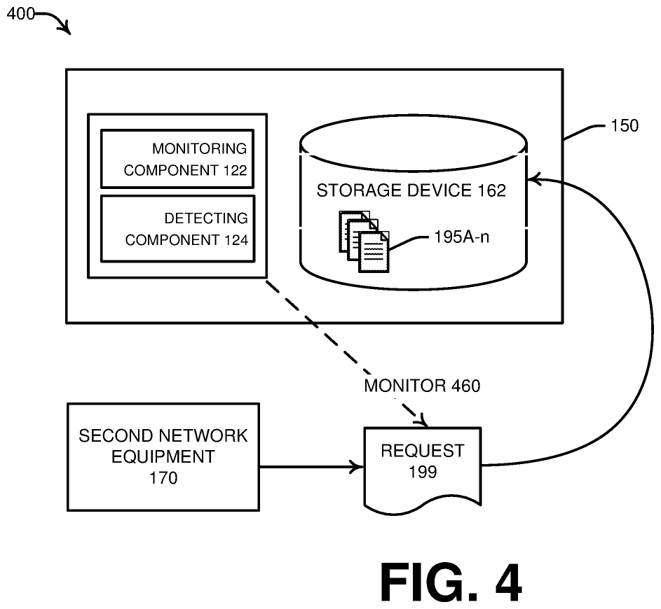

FIG. 4 depicts a diagram of an example network environment 400. At act 1, a service, or application, or client application, running on storage 162, which as discussed above may be a NAS, causes the storage to transmit lure query 197 to network 190. The application running on storage 162 causes the storage to transmit at act 2 a lure response message 198. Lure query message 197 and lure response message 198 appear to comprise legitimate commands or instructions regarding interesting information that an attacker, such as attacker 405, may be interested in, as described above. Lure response 198 may include fake information regarding a fake, or nonexistent file, or a fake location of a file that appears to be stored on storage 162. At act 3, attacker 405 detects on network 190 the sequence of lure query 197 and lure response 198, which appears to be responsive to the lure query. At act 4, attacker 405 transmits via network 190 a lure request 199 for information from storage 162 according to the fake information that may have been contained in lure response 198. At act 5 storage 162 determines that request 199 (at which point lure request 199 may be referred to as a determined lure request) originated from a source that is not authorized to access storage 162 based on the request for fake information being transmitted from second network equipment 170 according to fake information that may have been included in lure response 198. A basis for determining that request 199 comes from an unauthorized source is that a request that is directed to lure information contained in a lure query message 197 or a lure response message 198 would not likely originate from a source that is authorized to request information from storage 162 (e.g., has an account and login credentials to access storage 162). Rather, a legitimate source that is authorized to obtain information from storage 162 would likely attempt to access real information 195 that is actually stored on storage 162 instead of nonexistent fake information corresponding to the lure query or the lure response.

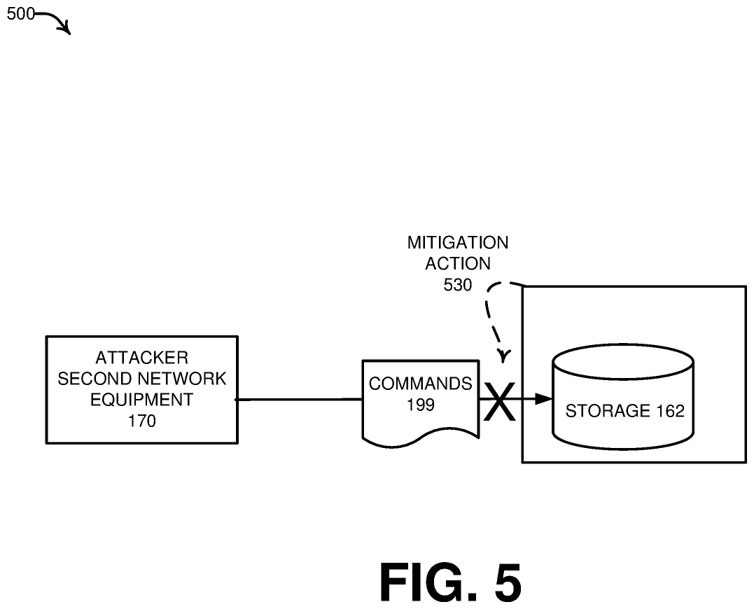

FIG. 5. illustrates security equipment 150 performing a mitigation action 530 after determining that a command 199 from second network equipment 170 is directed to information corresponding to, or included in, lure query message 197 or lure response message 198. Mitigation action 530 may comprise blocking access to storage 162 from second network equipment 170 as indicated in FIG. 5 with an ‘X’ between command 199 and storage 162, or the mitigation action may merely comprise notifying an administrator of security equipment 150 that second network equipment 170 may be associated with a malicious actor or malware.

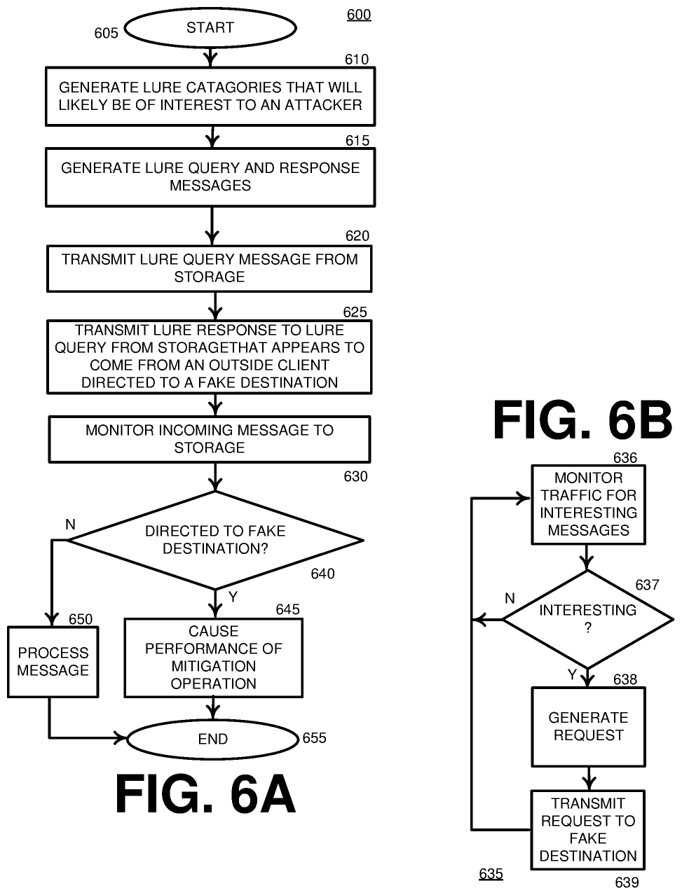

FIG. 6A depicts a flow diagram of an example method embodiment 600. Example method 600 begins at act 605. At act 610 security equipment, which may comprise storage 162 as described in reference to other figures herein, may generate lure categories that will likely appear to be associated with information that will likely be interesting to an attacker, a bad actor, or malware. At act 615 security equipment may generate lure query and response messages. The lure and response messages may comprise fake information that appears to be associated with categories of interest generated at act 610. The interesting information may be drawn from categories, for example, financial related topics or personal medical information related topics. The lure query or response messages may include a lure identifier, for example, an address of a component of the security equipment, for example storage 162, that may appear to be associated with information of interest, such as a file or directory or path. At act 620 a lure query message is transmitted from a component of the security equipment such as storage 162, to a network to which the storage is connected. At act 625 security equipment, for example storage 162, may transmit a lure response that is responsive to the lure query message. The lure query message may appear to come from an outside client and it may appear to be directed to a destination, that is a fake destination, such as a lure identifier referenced above. The lure response message corresponding to the lure query message may appear to originate from storage 162 and may appear to comprise interesting information, or may appear to identity interesting information that may be accessed by transmitting a request, such as request 199 described above, according to a fake identifier, such as an address contained in the lure query message to which the lure response message was responsive. At act 630 security equipment may monitor a communication network, to which components of the security equipment may be connected, to determine whether a message has been transmitted from network equipment that is not associated with the security equipment and that is directed to the lure identifier or interesting lure information that may have been part of the lure query or response messages generated at act 615.

At act 640 security equipment may determine whether a message detected on a network to which the security equipment is connected is directed to the fake lure information or fake lure identifier. If a message detected on the network is not directed to the fake lure information, example method 600 advances to act 650, security equipment processes the detected message, and example method 600 ends at act 655.

Returning to discussion of act 640, if a determination is made that a message detected at act 630 is directed to the fake lure information, or a fake lure identifier, security equipment may perform, or cause to be performed, a mitigation action or operation, such as, for example, blocking access to network equipment that transmitted the message detected at act 630, which message is directed to the fake lure information or fake or identifier. The mitigation action performed at act 645 may comprise blocking access to commands from network equipment from which the message directed to the fake interesting information, lure information, or lure identifier, originated. A mitigation action performed at act 645 may comprise notifying administrative personnel associated with security equipment 150, or storage 162, that the message detected at act 630 is associated with network equipment that is likely operated by a bad actor or operated by network equipment that likely comprises malware such that the administrative personnel may block future access to request messages received from the network equipment that generated the request for lure information that was detected at act 630. Example method 600 ends at act 655.

Turning now to FIG. 6B, the figure illustrates acts of method 635 that may be performed by network equipment that detects a lure query message or a lure response message. The network equipment that performs acts of method 635 may be referred to as malicious network equipment and may be referred to as second network equipment 170 described elsewhere herein, and may comprise equipment that has been programmed to, configured for, or that is operated by, malware or a malicious actor. At act 636 the malicious network equipment passively monitors message traffic, on a network to which it is connected, for storage access commands and messages that appear to include information that sounds interesting, for example, information indicative of financial-related information or personal information such as medical information. At act 635 the malicious network equipment determines that a detected, or monitored, message does not contain interesting information method, method 635 returns to act 636 and continues to monitor the network to which the malicious network equipment is connected for interesting messages. If, however, at act 635 the malicious network equipment determines that a message that it has detected comprises interesting information the malicious network equipment may change from a passive mode to an active mode at act 635 and generate a request (e.g., a request 199 described elsewhere herein) directed to an identifier corresponding to a message that the malicious network equipment detected at 636 and determined at act 640 as containing interesting information. The malicious network equipment may transmit the request to an identifier which may be a lure identifier or fake information as discussed in reference to figures elsewhere here in, at act 639. In an example, a lure identifier may comprise an address sent as a source address in a lure query message or may comprise a destination address of a lure response message. Acts of method 635 may be performed temporally between the performing of act 625 and the monitoring at 630 as described in reference to FIG. 6A.

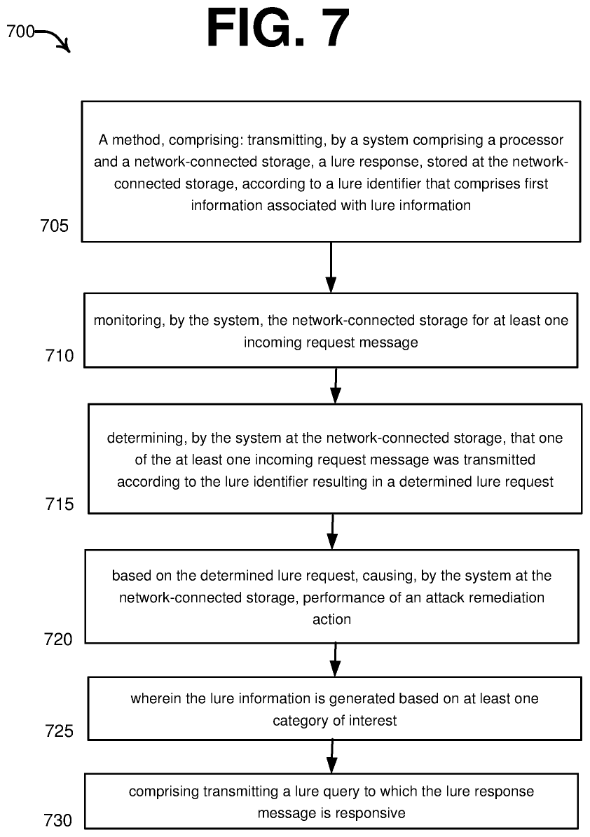

Turning now to FIG. 7, the figure illustrates an example embodiment method 700 comprising at block 705 transmitting, by a system comprising a processor and a network-connected storage, a lure response, identifying information that appears to be stored at the network-connected storage, according to a lure identifier that comprises first information (e.g., an address of storage 162 or information regarding how to request fake information) associated with lure information; at block 710 monitoring, by the system, the network-connected storage for at least one incoming request message; at block 715 determining, by the system at the network-connected storage, that one of the at least one incoming request message was transmitted according to the lure identifier resulting in a determined lure request; at block 720 based on the determined lure request, causing, by the system at the network-connected storage, performance of an attack remediation action; at block 725 wherein the lure information is generated based on at least one category of interest; and at block 730 comprising transmitting a lure query to which the lure response message is responsive.

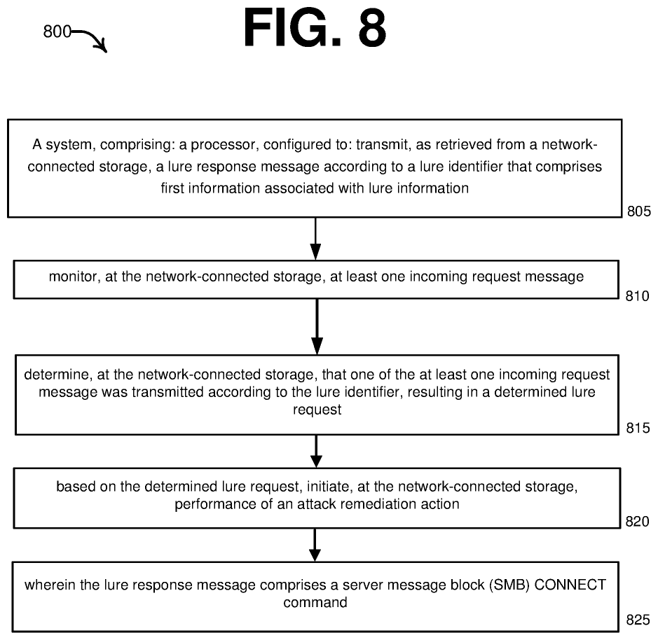

Turning now to FIG. 8, the figure illustrates an example system embodiment 800 comprising at block 805 a processor configured to: transmit, as retrieved from a network-connected storage, a lure response message according to a lure identifier that comprises first information associated with lure information; at block 810 monitor, at the network-connected storage, at least one incoming request message; at block 815 determine, at the network-connected storage, that one of the at least one incoming request message was transmitted according to the lure identifier, resulting in a determined lure request; at block 820 based on the determined lure request, initiate, at the network-connected storage, performance of an attack remediation action; and at block 825 wherein the lure response message comprises a server message block (SMB) CONNECT command.

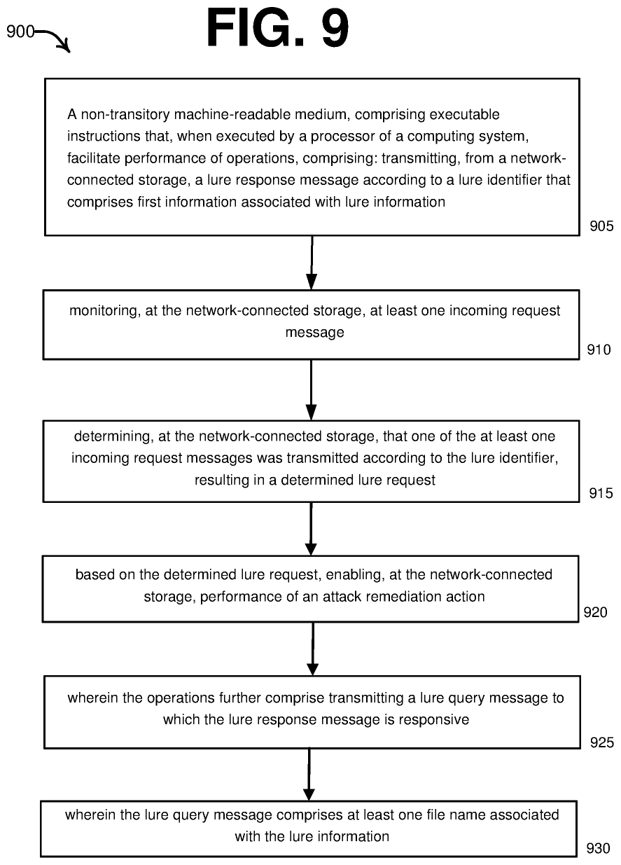

Turning now to FIG. 9, the figure illustrates a non-transitory machine-readable medium 900 comprising at block 905 executable instructions that, when executed by a processor of a computing system, facilitate performance of operations, comprising: transmitting, from a network-connected storage, a lure response message according to a lure identifier that comprises first information associated with lure information; a block 910 monitoring, at the network-connected storage, at least one incoming request message; at block 915 determining, at the network-connected storage, that one of the at least one incoming request messages was transmitted according to the lure identifier, resulting in a determined lure request; at block 920 based on the determined lure request, enabling, at the network-connected storage, performance of an attack remediation action; at block 925 wherein the operations further comprise transmitting a lure query message to which the lure response message is responsive; and at block 930 wherein the lure query message comprises at least one file name associated with the lure information.

Communication between network equipment via a network can be in the form of a data packet adapted to be transmitted between two or more computer processes. Another possible communication between network equipment via a network can be in the form of circuit-switched data adapted to be transmitted between two or more computer processes in radio time slots.

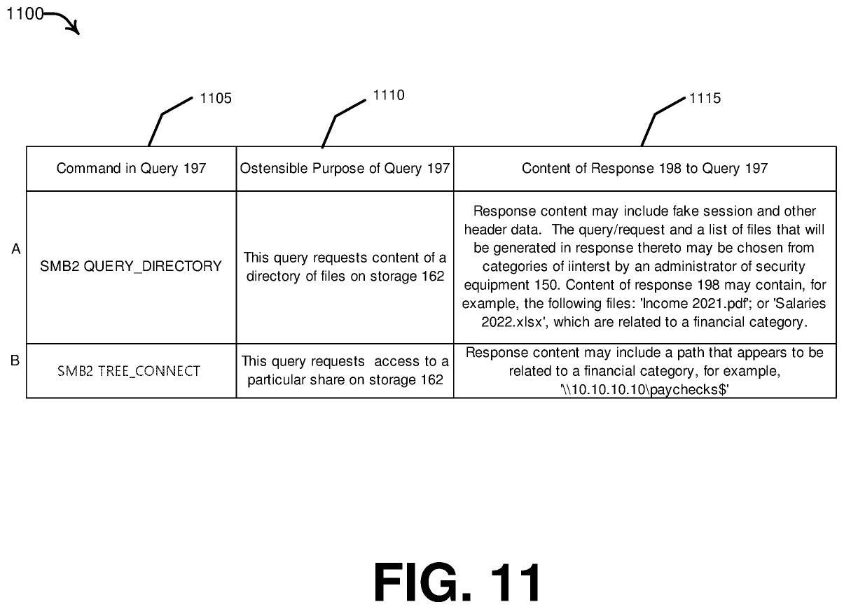

FIG. 11 illustrates a table 1100 that shows example file access commands 1105, which may comprise SMB commands, that may be part of a lure query message 197. Table 1100 shows apparent, or ostensible, purposes 1110 of commands 1105 in query message 197. The term ‘apparent’ or ‘ostensible’ is used to highlight that the nature of a lure query is not to actually request content of a directory using an SMB2 QUERY_DIRECTORY command 1105A or to request to an actual file sharing connection using an SMB2 TREE_CONNECT command 1105B, but to merely lure, or entice, a malicious actor, or malware operating network equipment, into requesting, via a request message 199 as discussed elsewhere herein, access that corresponds to the command 1105 of a given lure query. Table 1100 also shows responses 1115 that may comprise fake response information, which may comprise information that would likely be interesting to a malicious actor, in lure response messages 198 that are responsive to lure query messages 197. Content of a response message 198 may comprise fake session or header information that an attacker, or maliciously programmed network equipment, may use to try to access a NAS storage. The use of the session or header information may be used by a monitoring component 122 or a detecting component at security equipment 150 to determine that a message from network equipment may comprise an attack on a component of the security equipment, such as storage 162.

In an example, a lure query 197 may comprise a command 1105A that may comprise a request for directory information from a NAS. A lure response message 198 corresponding to the lure query 197 may comprise information, such as a list of files that could be accessed from the directory requested by command 1105A. The topic, or category, of information that may be used in file names in a lure response may be selected by an administrator or may be automatically selected from a list of categories by a processor under control of software performing embodiments act discussed herein. An administrator may choose, for example, a financial category which might result in file names 1115A listed in response to a command 1105A to detect, determine, or identity, a network equipment source (e.g., an address) of a malicious attempt to access what appears to be financial records, for example in what appears to be files 195 shown in FIG. 1 stored on storage 162, which file or files may not actually be files, as described elsewhere herein. Response content 1115B of a lure response message 198 may include what appears to be a path to interesting-sounding, or interesting-appearing, information such as ‘paycheck’ information, in response to a lure query using an SMB2 TREE_CONNECT command 1105B.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer-executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
transmitting, by a system comprising a processor and a network-connected storage, a lure response, stored at the network-connected storage, according to a lure identifier that comprises first information associated with lure information;
monitoring, by the system, the network-connected storage for at least one incoming request message;
determining, by the system at the network-connected storage, that one of the at least one incoming request message was transmitted according to the lure identifier resulting in a determined lure request; and
based on the determined lure request, causing, by the system at the network-connected storage, performance of an attack remediation action.

2. The method of claim 1, wherein the lure response comprises a server message block CONNECT command.

3. The method of claim 1, wherein the lure information is generated based on at least one category of interest.

4. The method of claim 3, wherein the at least one category of interest comprises at least one: a first category relating to a non-publicly known technology, a second category relating to a first location of a meeting, a third category relating to planning of an event, a fourth category relating to finance, a fifth category relating to a status of an individual, a sixth category relating to a second location of the individual, a seventh category relating to a personal record of the individual, an eighth category relating to a third location of an item, a ninth category relating to a fourth location associated with a shipment of the item, a tenth category relating to shipping information associated with shipping the shipment, an eleventh category relating to health care, or a twelfth category relating to a military application.

5. The method of claim 1, further comprising generating, by the system at the network-connected storage, the lure identifier, wherein the lure identifier comprises a lure address.

6. The method of claim 1, wherein the lure identifier comprises information in a path format.

7. The method of claim 1, further comprising transmitting, by the system, a lure query to which the lure response message is responsive.

8. The method of claim 7, wherein the lure query message comprises second information associated with the lure information different than the first information.

9. A system, comprising:
a processor, configured to:
transmit, as retrieved from a network-connected storage, a lure response message according to a lure identifier that comprises first information associated with lure information;
monitor, at the network-connected storage, at least one incoming request message;
determine, at the network-connected storage, that one of the at least one incoming request message was transmitted according to the lure identifier, resulting in a determined lure request; and
based on the determined lure request, initiate, at the network-connected storage, performance of an attack remediation action.

10. The system of claim 9, wherein the lure response message comprises a server message block CONNECT command.

11. The system of claim 9, wherein the lure information is generated based on at least one of a group of categories of interest, the group of categories comprising: a first category relating to secret technology, a second category relating to a first location of a meeting, a third category relating to a planning of an event, a fourth category relating to finance, a fifth category relating to a status of an individual, a sixth category relating to a second location of the individual, a seventh category relating to a personal record of the individual, an eighth category relating to a third location of an item, a ninth category relating to a fourth location of a shipment of the item, a tenth category relating to shipping information associated with a destination of the shipment, an eleventh category relating to health care, and a twelfth category relating to a military technology.

12. The system of claim 9, wherein the lure identifier comprises second information in an address format.

13. The system of claim 9, wherein the processor is further configured to generate the lure identifier.

14. The system of claim 9, wherein the processor further is configured to transmit a lure query message to which the lure response message is responsive.

15. A non-transitory machine-readable medium, comprising executable instructions that, when executed by a processor of a computing system, facilitate performance of operations, comprising:
transmitting, by a network-connected storage of the computing system, a lure response message according to a lure identifier that comprises first information associated with lure information;
monitoring, at the network-connected storage, at least one incoming request message;
determining, at the network-connected storage, that one of the at least one incoming request messages was transmitted according to the lure identifier, resulting in a determined lure request; and
based on the determined lure request, enabling, at the network-connected storage, performance of an attack remediation action.

16. The non-transitory machine-readable medium of claim 15, wherein the operations further comprise generating, at the network-connected storage, the lure identifier.

17. The non-transitory machine-readable medium of claim 15, wherein the lure identifier comprises second information in a path format.

18. The non-transitory machine-readable medium of claim 15, wherein the operations further comprise transmitting a lure query message to which the lure response message is responsive.

19. The non-transitory machine-readable medium of claim 18, wherein the lure query message comprises second information associated with the lure information different from the first information.

20. The non-transitory machine-readable medium of claim 18, wherein the lure query message comprises at least one file name associated with the lure information.
